(19) United States
(12) Patent Application Publication
(10) Pub. No.: US 2008/0172857 A1
(43) Pub. Date: Jul. 24, 2008

(54) Systems and Methods for Manipulating a Frame in a Manufacturing Process

(75) Inventors: Alan Brinkworth, Chattanooga, TN (US); Brent E. Boxall, Lafayette, GA (US)

Correspondence Address: SUTHERLAND ASBILL & BRENNAN LLP, 999 PEACHTREE STREET, N.E., ATLANTA, GA, 30309, US

(73) Assignee: TENNESSEE RAND AUTOMATION, Chattanooga, TN (US)

(21) Appl. No.: 11/968,562

(22) Filed: Jan. 2, 2008

Related U.S. Application Data
(60) Provisional application No. 60/883,532, filed on Jan. 5, 2007.

(51) Int. Cl. B25B 11/00; B23Q 3/00; B23Q 7/00

(52) U.S. Cl. 29/559; 269/37; 901/50; 901/14

(57) ABSTRACT

Embodiments of the invention relate to systems and methods for manipulating a frame in a manufacturing process. In one embodiment of the invention, a system with at least one robot with a pair of robotic arms can be deployed in a manufacturing process. A frame associated with the manufacturing process can include a first portion operable to be manipulated by the robot or one robot arm, and a second portion operable to be manipulated by the robot or the other robot arm. An associated control device, such as a computer or software program, can coordinate operation, movement, and control of the robot, including the pair of robotic arms.

### RELATED APPLICATION

This application claims priority to U.S. Ser. No. 60/883,582, entitled “Systems and Methods for Manipulating a Frame in a Manufacturing Process”, filed Jan. 5, 2007, the contents of which are hereby incorporated by reference.

### FIELD OF THE INVENTION

This invention relates to robotics, and in particular, relates to systems and methods for manipulating a frame for a manufacturing process.

### BACKGROUND OF THE INVENTION

Manufacturing facilities increasingly rely on robotic equipment to perform or otherwise assist personnel in performing manufacturing and process tasks. In some manufacturing facilities, particular tasks can be organized at one or more workstations to permit tasks to be efficiently performed. In certain instances, various machines and equipment can be deployed by personnel at a workstation to perform or assist in performing the tasks. Depending on the tasks to be performed during a manufacturing process, certain types of other equipment can be used to assist personnel.

For example, at an airplane manufacturing facility, a workstation for making an airplane wing can be used. Specialized machines and equipment, such as a stationary C-frame device, can be deployed at the workstation to perform various tasks including, but not limited to, welding, punching, cutting, bending, and fastening. In an airplane wing assembly process, a conventional stationary C-frame device can be used by personnel at an airplane wing assembly workstation. Typically, a stationary C-frame device can include an upper head and a lower head. Various process equipment can be mounted to the upper head and lower head, including drills, rams, spindles, applicators, drills, and clamps. For example, a conventional stationary C-frame device can be mounted at an airplane wing assembly workstation, and personnel can position an airplane wing component between the upper head and lower head as needed to permit personnel to operate various process equipment and perform certain tasks with respect to the airplane wing component. In particular, personnel can operate clamps associated with a C-frame device to apply pressure to one or more layers of an airplane wing component, drill holes through the layers of the airplane wing component, and insert one or more fasteners into the airplane wing component. In certain instances, relatively high forces and pressures must be applied to multiple layers of an airplane wing component during drilling to minimize or otherwise avoid drill “burrs” from forming between the layers of the airplane wing component. Due to the relatively high forces and pressures applied to airplane wing components during these processes, a stationary C-frame device is relatively large and heavy to apply and to withstand such forces and pressures. For example, a conventional stationary C-frame device configured to drill holes in and apply fasteners to an airplane wing component may take up extensive floor space and weigh approximately 25,000 pounds.

In some instances, a conventional C-frame device can be mounted on a relatively straight track. These types of C-frame devices can be operated along the track and along a product component positioned adjacent to the C-frame device and track.

The relative lack of flexibility by conventional stationary and track-mounted C-frame devices and similar equipment can sometimes slow or otherwise hinder certain tasks associated with manufacturing or other processes. For instance, in order to perform certain tasks with a conventional stationary and track-mounted C-frame devices, such as drilling and fastening, particular product components must be positioned or oriented with respect to the C-frame device. For some shaped or contoured product components, such as an airfoil-shaped wing component or other contoured product component, positioning and orienting the wing or other contoured component with respect to the stationary or track-mounted C-frame device can be difficult and demanding. In some instances, expensive part or component positioning equipment and hardware may be used. Manufacturing process and cycle time and associated costs may increase when product components, such as a wing component, need to be constantly adjusted, manipulated, or monitored in order to perform tasks using a conventional stationary or track-mounted C-frame device in conjunction with part or component positioning equipment and hardware.

Therefore, a need exists for systems and methods for manipulating a frame in a manufacturing process.

A further need exists for system and methods for manufacturing a product component.

### SUMMARY OF THE INVENTION

Systems and methods according to various aspects and embodiments according to the invention address some or all of these issues and combinations of them. They do so by providing systems and methods for manipulating a frame in a manufacturing process. Other embodiments of the invention relate to systems and methods for manufacturing a product component. In one embodiment of the invention, a system with at least one robot with a pair of robotic arms can be deployed in a manufacturing process. A frame, such as a C-frame, associated with the manufacturing process can include a first portion operable to be manipulated by the robot or one robot arm, and a second portion operable to be manipulated by the robot or the other robot arm. An associated control device, such as a computer or software program, can coordinate operation, movement, and control of the robot, including the pair of robotic arms. In this manner, the robot or robot arms can manipulate the portions of the frame with respect to a product component, such as a contoured product component in a manufacturing process, thereby reducing manufacturing process and cycle time and associated costs. Embodiments of the invention are not limited to a particular type of frame or robot in a certain manufacturing process, but can also include other types of frames and robots in various types of manufacturing and other process settings.

Embodiments of the invention can also include a system for manipulating a frame in a manufacturing process. The system can include a first robot operable to manipulate a first frame. The system can also include a second robot operable to manipulate a second frame. In addition, the system can include a control device capable of coordinating movement of the first robot and the second robot.

In one aspect of this embodiment, the control device can manipulate the first robot with respect to a product component, and can further manipulate the second robot with respect to the product component.

In another aspect of this embodiment, the system can include at least one tool operable to mount to either the first frame or the second frame.

In another aspect of this embodiment the control device can manipulate the at least one tool with respect to a product component.

In another aspect of this embodiment, the first frame can include one portion of a C-frame, and the second frame can include another portion of the C-frame.

In another aspect of this embodiment, the first frame mounts to the first robot, and the second frame mounts to the second robot.

In another aspect of this embodiment, the first frame and the second frame can be manipulated by the system at substantially the same time.

In another aspect of this embodiment, the first robot and second robot can comprise an integrated robot.

In another aspect of this embodiment, the control device comprises at least one of the following: a software program, a computer-readable medium comprising a set of computer-executable instructions, or programmable logic controller (PLC).

In another aspect of this embodiment, the product component can include at least one of the following: a bicycle, a motorcycle, an automobile, an airplane, an airplane wing, or an appliance

Embodiments of the invention can also include a method for manipulating a frame in a manufacturing process. The method can include providing at least one robot with a first mount operable to mount to a portion of a first frame, and a second mount operable to mount to a portion of a second frame. Further, the method can include mounting a first frame to the first mount, and mounting a second frame to the second mount. In addition, the method can include manipulating the first mount and second mount, wherein the first frame and the second frame can be manipulated at substantially the same time.

In one aspect of the embodiment, the first frame is a portion of a C-frame, and the second frame is another portion of a C-frame.

In another aspect of the embodiment, the robot can include a pair of robot arms, wherein the first mount is associated with one robot arm, and the second mount is associated with the other robot arm.

In another embodiment of the invention, a method for manipulating a frame in a manufacturing process can be provided. The method can include providing at least one robot with a first mount operable to mount to a portion of a first frame, and a second mount operable to mount to a portion of a second frame. In addition, the method can include mounting the first frame to the first mount, and mounting the second frame to the second mount. Furthermore, the method can include manipulating the first frame and the second frame via the at least one robot, wherein the first frame and the second frame can be manipulated at substantially the same time.

In one aspect of this embodiment, the first frame is a portion of a C-frame, and the second frame is another portion of a C-frame.

In another aspect of the embodiment, the at least one robot can include at least a pair of robot arms, wherein the first mount is associated with one robot arm, and the second mount is associated with another robot arm.

In another aspect of the embodiment, manipulating the first mount and second mount can include transmitting a command to a control device to manipulate the first frame, and transmitting another command to the control device to manipulate the second frame.

In another aspect of the embodiment, mounting at least one tool to either the first frame or the second frame.

In another aspect of the embodiment, manipulating the first frame and the second frame can include manipulating the first frame with respect to a product component, and manipulating the second frame with respect to the product component.

In another aspect of the embodiment, the product component can include at least one of the following: a bicycle, a motorcycle, an automobile, an airplane, an airplane wing, or an appliance.

In another aspect of the embodiment, manipulating the first frame and the second frame can include transmitting at least one instruction to the at least one robot from at least one of the following: a software program, a computer-readable medium comprising a set of computer-executable instructions, or programmable logic controller (PLC).

In yet another embodiment, a system for manufacturing a product component can be provided. The system can include at least one robot, which can include a first robot arm with at least one mount and a second robot arm with at least one mount. The system can also include a frame, which can include a first frame operable to mount to the first robot arm for manipulation by the first robot arm, and a second frame operable to mount to the second robot for manipulation by the second robot arm. In addition, the system can include at least one tool operable to mount to either the first frame or the second frame. Furthermore, the system can include a control device operable to coordinate simultaneous movement of the first robot arm and the second robot arm with respect to a product component, and further operable to manipulate the at least one tool with respect to the product component.

In one aspect of this embodiment, the product component can include at least one of the following: a bicycle, a motorcycle, an automobile, an airplane, an airplane wing, or an appliance.

Therefore various systems and processes according to various embodiments of the invention can include:

(1) Systems and methods for manipulating a frame in a manufacturing process; and

(2) Systems and methods for manufacturing a product component.

Other systems and methods according to various embodiments of the invention will become apparent with respect to the remainder of this document.

### BRIEF DESCRIPTION OF THE DRAWINGS

FIGS. 1A and 1B are illustrations of an example prior art system with a conventional C-frame device in a manufacturing environment.

FIGS. 2A and 2B are illustrations of an example system in accordance with an embodiment of the invention.

FIG. 3 is an illustration of another example system in accordance with an embodiment of the invention.

FIG. 4 is a flowchart for an example method in accordance with an embodiment of the invention.

### DETAILED DESCRIPTION OF EMBODIMENTS OF THE INVENTION

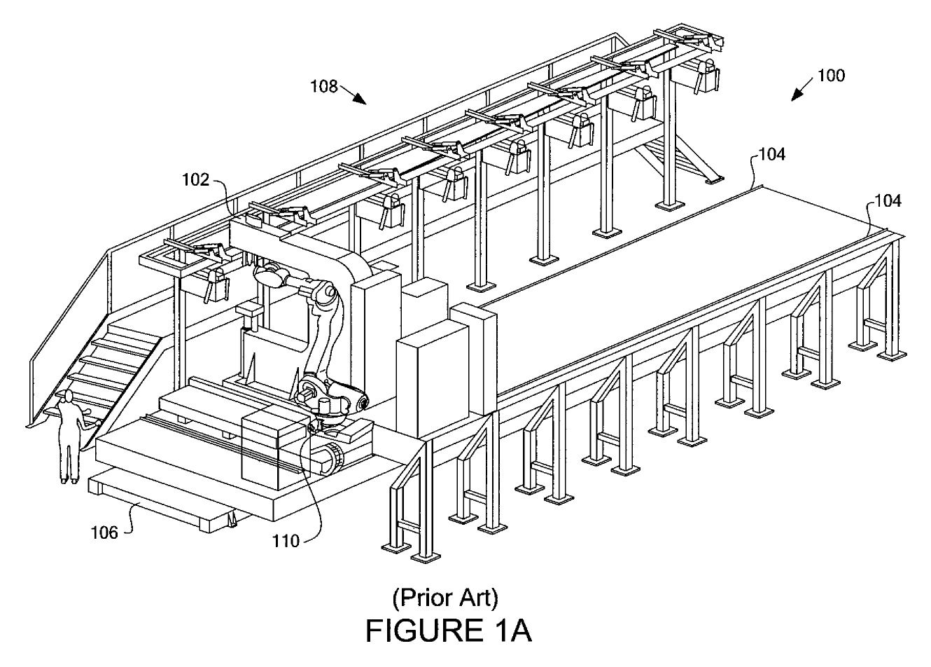

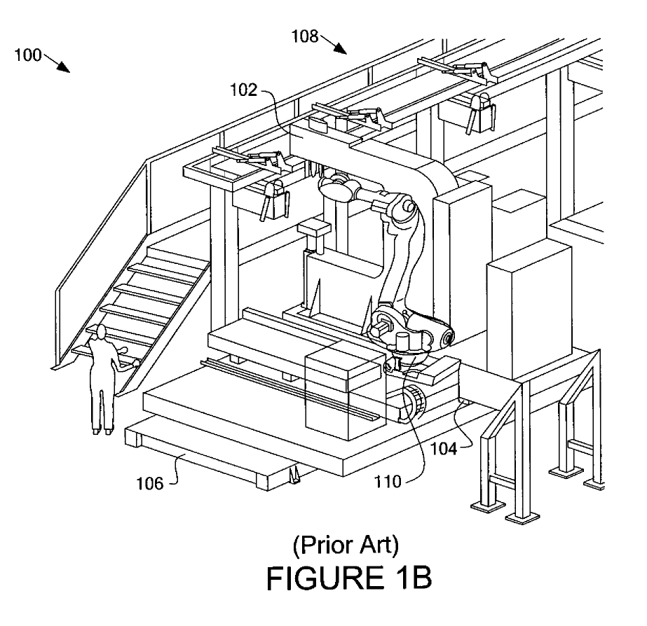

An example prior art conventional C-frame system is illustrated in FIG. 1A as 100. FIG. 1B shows a larger view of certain elements of the C-frame system 100 shown in FIG. 1A. A conventional C-frame 102 mounted to a set of tracks 104 and support structure 106 is shown relative to a component positioning structure 108. The C-frame 102 can move along the track 104 relative to the support structure 106 and the component positioning structure 108, while performing certain tasks to a product component 110 mounted to the component positioning structure 108. In certain instances, an associated robot 112 may assist the C-frame 102 in performing certain tasks associated with the product component 110.

Embodiments of the invention relate to systems and methods for manipulating a frame in a manufacturing process. Other embodiments of the invention relate to systems and methods for manufacturing a product component. In one embodiment of the invention, a system with at least one robot with a pair of robotic arms can be deployed in a manufacturing process. A frame, such as a C-frame, associated with the manufacturing process can include a first portion operable to be manipulated by the robot or one robot arm, and a second portion operable to be manipulated by the robot or the other robot arm. An associated control device, such as a computer or software program, can coordinate operation, movement, and control of the robot, including the pair of robotic arms. In this manner, the robot or robotic arms can manipulate the portions of the frame with respect to a product component, such as a contoured product component, in a manufacturing process, thereby reducing manufacturing process and cycle time and associated costs. Embodiments of the invention are not limited to a particular type of frame or robot in a certain process, but can also include other types of frames and robots in various types of manufacturing and other process settings.

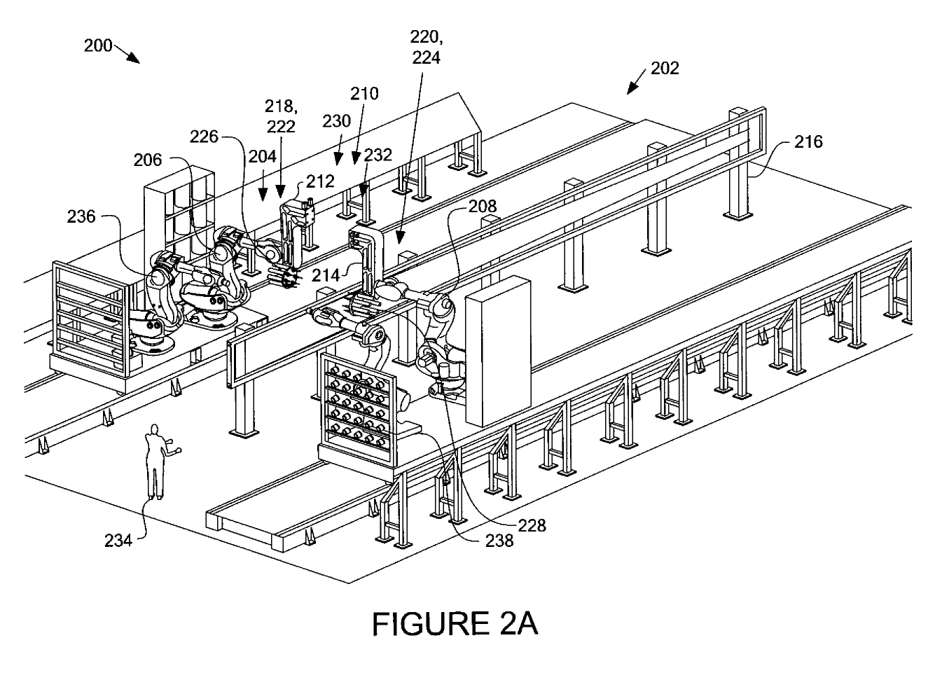

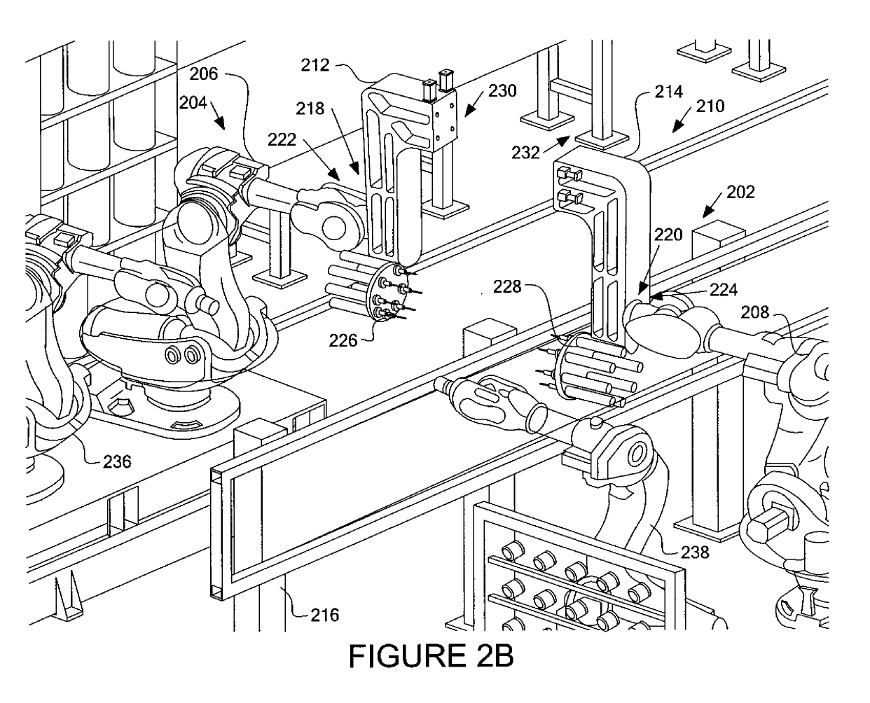

An example environment and system in accordance with an embodiment of the invention are shown in FIGS. 2A and 2B. FIGS. 2A and 2B illustrate an example manufacturing environment 200 for an example system 202 in accordance with various embodiments of the invention. FIG. 2B shows a larger view of certain elements of the example system 202 shown in FIG. 2A. A suitable manufacturing environment for an example system can be any assembly process or plant for a variety of goods including, but not limited to, a bicycle, a motorcycle, an automobile, an airplane, an airplane wing, and an appliance.

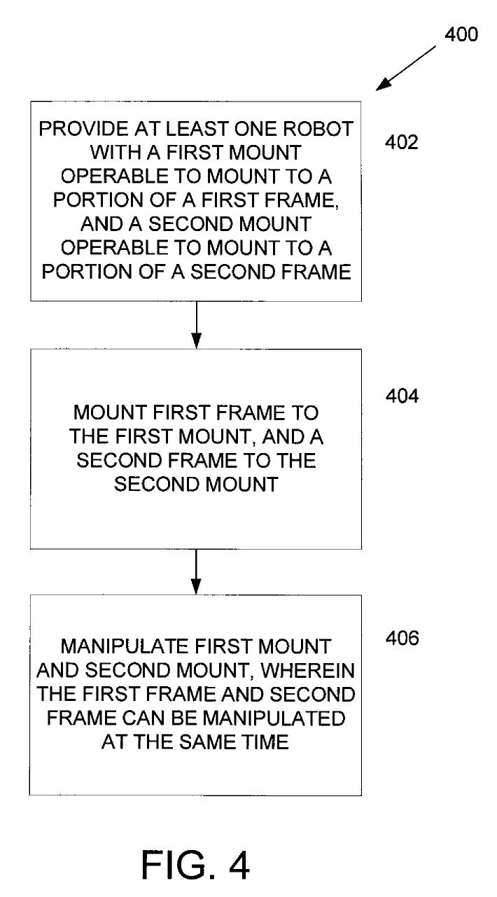

Using the example system 202 illustrated in FIGS. 2A and 2B, the example method described in FIG. 4 can be implemented. The system 202 shown in FIGS. 2A and 2B includes at least one robot 204, shown in this embodiment as a pair of robot arms 206, 208, a frame 210, shown in this embodiment as two portions 212, 214 of a C-type frame, and a main control device (not shown). In one embodiment, the system 202 can include a product component structure, such as 216, operable to mount a product component relative to the robot 204 and frame 210. Example product components can include, but are not limited to, a bicycle, a motorcycle, an automobile, an airplane an airplane wing, and an appliance. The configuration and arrangement of the components shown and described with respect to FIGS. 2A and 2B are shown by way of example only, and other configurations and arrangements of system components can exist in accordance with other embodiments of the invention. Furthermore, the example method of FIG. 4 can be implemented with other system embodiments of the invention.

In the embodiment shown in FIGS. 2A and 2B, the robot 204 can perform a variety of movements and actions, and can be positioned in multiple positions. The robot 204 can be a single, integrated unit, or may include multiple, independently controlled units. In general, a robot can include one or more robot arms or other automated equipment for use in a manufacturing process. For example, a robot can include a pair of robot arms for use in performing certain tasks in a manufacturing assembly process. As shown in FIGS. 2A and 2B, the robot 204 in this embodiment can include a pair of robot arms 206, 208 which can be independently controlled but operated in conjunction with each other to perform coordinated movements. An example of a suitable robot includes, but is not limited to, a robot and associated robot arm provided by Asea Brown Boveri (ABB) Ltd. of Switzerland.

As shown in FIGS. 2A and 2B, the robot arms 206, 208 can be mounted to respective portions 212, 214 of the frame 210. Each 212, 214 portion of the frame 210 includes a respective robot mount 218, 220 operable to receive a portion of the robot 204, such as a respective robot arm 206, 208. Thus, the robot 204 and/or associated robot arms 206, 208 can have corresponding mounts 222, 224. An example of a suitable mount can include, but is not limited to, an ATI-type quick change device, such as a QC-210 or QC-310 robotic tool changer connector device, distributed by ATI Industrial Automation of Apex, North Carolina, United States of America.

In the embodiment shown in FIGS. 2A and 2B, the frame 210 can include at least two portions, such as a 212, 214, but may include any number of corresponding portions. The frame 210, including each of the frame portions 212, 214, can have various associated process equipment 226, 228 mounted to the frame 210, including drills, rams, spindles, applicators, drills, and clamps. In the embodiment shown, the frame portions 212, 214 can be mounted to each other via corresponding frame mounts 230, 232. Examples of suitable frame mounts can include, but are not limited to, mechanical-type clamps or fasteners, and hydraulic-type clamps or fasteners. In this embodiment, the frame portions 212, 214 can be aligned with each other, and the frame mounts 230, 232 can be mounted to each other. In another embodiment, the frame portions 212, 214 can be aligned with each other, and the frame mounts 230, 232 can be maintained in close proximity and alignment with each other. In any instance, the frame portions 212, 214 can be manipulated by a robot, such as 204, or respective robot arms, such as 206, 208, such that the operation, movement, and control of the frame portions can be coordinated. For instances utilizing multiple frame portions, associated robots can be mounted to respective frame portions and used in accordance with embodiments of the invention.

In the embodiment shown, the robot 204, and associated robot arms 206, 208, can be in communication with a main control device. Typically, the main control device can facilitate communications, such as control and feedback commands and signals, between the robot 204 and a user, such as 234. The main control device can include a control program or other instructions operable to coordinate operation, movement, and control of the robot 204, or one or more robot arms 206, 208. In one example, a main control device can be programmed to manipulate opposing portions 212, 214 of a frame 210, and rotate the frame 210 about a product component mounted to a product component structure 216 to perform one or more tasks with respect to the product component, as well as along the length of the product component. In another example, a main control device can be programmed to manipulate a pair of robot arms, such as 206, 208, implement respective tools mounted on opposing portions, such as 212, 214, of a frame 210, and perform simultaneous or near simultaneous tasks using the tools with respect to a product component mounted to a product component structure, such as 216. In yet another example, a main control device can be programmed to move in coordinated fashion a pair of robot arms, such as 206, 208, along respective tracks, similar to 104 in FIG. 1 or shown in FIGS. 2A and 2B, and with respect to a product component mounted to a product component structure, such as 216.

In one embodiment, a main control device can control two robot arms 206, 208, with one arm leading and the other arm following the movement of the leading arm.

In another embodiment, a main control device can be programmed or otherwise trained using software and a 3-D model of a product component. For example, a 3-D model of a product component can be developed to determine orientations and positions for fasteners to be applied to the product component. In this manner, a main control device can utilize the 3-D model to coordinate operation, movement, and control of one or more robots and any respective associated robot arms. A suitable modeling software program is the RobotStudio™ software program provided by Asea Brown Boveri (ABB) Ltd. of Switzerland.

For embodiments including multiple frame portions and robots, a main control device can include a control program or other instructions operable to coordinate operation, movement, and control of some or all of the robots and associated frame portions. In some embodiments, additional robots and robot arms, such as 236, 238 can cooperate with and may be controlled by the system 202 and main control device. A suitable main control device can include, but is not limited to, a Model IRC5 robot controller provided by Asea Brown Boveri (ABB) Ltd. of Switzerland.

Those skilled in the art will recognize the various embodiments for a main control devices, programs, instructions, and the implementation of these devices, programs, and instructions in accordance with the invention. For example, control of the robot 204 and associated robot arms 206, 208 can be facilitated by a user interacting with the main control device, such as a computer executing a software program, via an associated I/O device, such as an output display, keyboard, or mouse. In one embodiment, a main control device can be a programmable logic controller (PLC) operable to execute a set of instructions. In another embodiment, a main control device may be a processor hosted by one or more processor-based platforms such as those implemented by Windows 98, Windows NT/2000, LINUX-based and/or UNIX-based operating platforms. Such a processor and associated platforms can utilize one or more conventional programming languages such as DB/C, C, C++, UNIX Shell, and Structured Query Language (SQL) to accomplish various methods, routines, subroutines, and computer-executable instructions in accordance with the invention, including system functionality, data processing, and communications between functional components.

In addition, one or more associated I/O devices can be provided for a main control device. A user can view an output, such as a signal or indicator generated by a main control device. Alternatively, a user may provide an input or other instruction for a main control device via a respective I/O device.

As shown in FIGS. 2A and 2B, a product component structure 216 can be a conventional device operable to mount a product component adjacent to a robot, such as 204, and frame, such as 210. For example, a product component can be a component of any manufactured or assembled device including, but not limited to, a bicycle, a motorcycle, an automobile, an airplane, and an appliance. In the embodiment shown in FIGS. 2A and 2B, the product component structure 216 is operable to mount an airplane wing component adjacent to the robot 204 and frame 210, and between the frame portions 212, 214 supported by respective robot arms 206, 208.

In use, the system 202 shown in FIGS. 2A and 2B can manipulate a frame for a manufacturing process or environment. A user, such as a manufacturing process operator, can mount a robot 204 to a first portion 212 of a frame 210, and mount the robot 204 to a second portion 214 of the frame 210. Receiving instructions from the user via a main control device, the robot 204 can manipulate the first portion 212 and second portion 214 of the frame 210, and mount the first portion 212 and second portion 214 to each other or in close proximity to each other. Various instructions can include, but are not limited to, movement of a respective robot, movement of a respective frame, movement of a tool, implementation of a tool, and any combination thereof.

In this manner, a user can coordinate operation, movement and control of the robot 204, or one or more robot arms 206, 208, to manipulate the frame 210 with respect to a product component, such as an airplane wing component mounted to a product component structure 216 positioned adjacent to the robot 204 and frame 210. Using associated process equipment 226, 228 mounted to the frame 210, including any number of drills, rams, spindles, applicators, drills, and clamps, the user can perform any number of desired tasks with respect to the product component.

In one aspect of the embodiment, the first portion is a portion of a C-frame, and the second portion is another portion of the C-frame.

In another aspect of the embodiment, the robot can include a pair of robot arms, wherein a first mount is associated with one robot arm, and a second mount is associated with the other robot arm.

In yet another aspect of an embodiment, a main control device can include a software program operable to manipulate the robot, including one or more robot arms.

In another aspect of an embodiment, a main control device can be a programmable logic controller (PLC) operable to execute a set of instructions operable to manipulate the robot, including one or more robot arms.

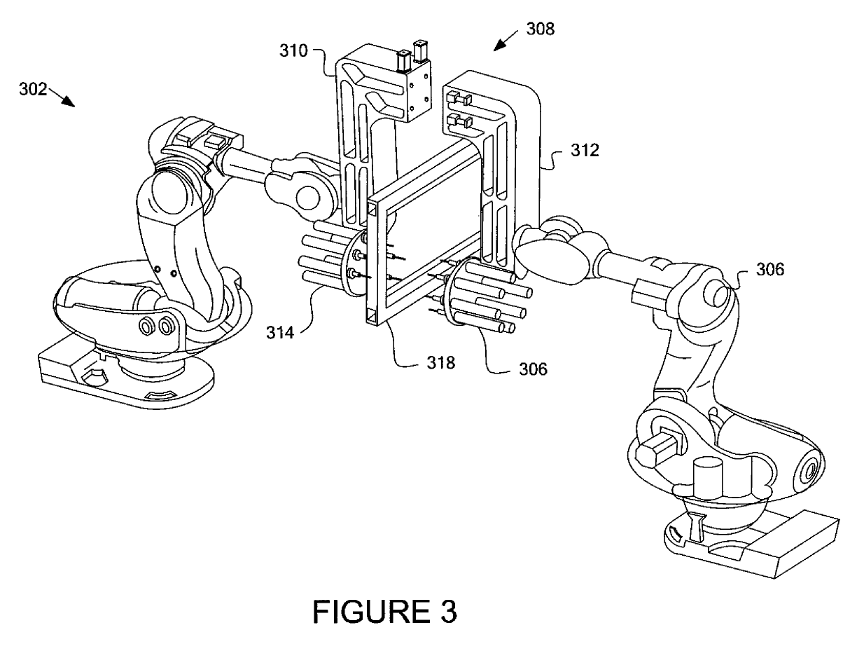

FIG. 3 illustrates another view of an example system in accordance with an embodiment of the invention. Using the example system 300 illustrated in FIG. 3, the example method described in FIG. 4 can be implemented. The system 300 shown in FIG. 3 is similar to the system 202 shown in FIGS. 2A and 2B, and includes a robot 302, shown in this embodiment as a pair of robot arms 304, 306, a frame 308, shown in this embodiment as two portions 310, 312 of a C-type frame, and a main control device (not shown). The frame 308, including each of the frame portions 310, 312, can have various associated process equipment 314, 316 mounted to the frame 308, including drills, rams, spindles, applicators, drills, and clamps. The configuration and arrangement of the components shown and described with respect to FIG. 3 is shown by way of example only, and other configurations and arrangements of system components can exist in accordance with other embodiments of the invention. Furthermore, the example method of FIG. 4 can be implemented with other system embodiments of the invention.

One example of a method for manipulating a frame in a manufacturing process is described in FIG. 4. The example method 400 can be performed by a system such as 202 in FIGS. 2A and 2B, and 300 in FIG. 3. Other embodiments of a method in accordance with the invention can include some or all of the following elements, fewer or greater elements than the number shown, and may have a different order of execution than the example method shown.

The method 400 shown in FIG. 4 begins at block 402. In block 402, at least one robot with a first mount operable to mount to a portion of a first frame, and a second mount operable to mount to a portion of a second frame are provided. In this embodiment, the robot can include a first mount operable to mount to a portion of a first frame. Furthermore, the robot can include a second mount operable to mount to a portion of a second frame. For example, as shown in FIG. 2A, at least one robot, such as 204, with first mount 222 and a second mount 224 can be provided.

In one aspect of the embodiment, the first frame is a portion of a C-frame, and the second frame is another portion of a C-frame.

In another aspect of the embodiment, the robot can include a pair of robot arms, wherein the first mount is associated with one robot arm, and the second mount is associated with the other robot arm.

Block 402 is followed by block 404, in which a first frame is mounted to the first mount, and a second frame is mounted to the second mount. In this embodiment, a first frame mounts to a first mount associated with the robot, and a second frame mounts to a second mount associated with the robot. For example, as shown in FIG. 2, a first frame, such as 212, mounts to a first mount, such as 222, associated with a robot, such as 204. A second frame, such as 214, mounts to a second mount, such as 224, associated with the robot, such as 204.

Block 404 is followed by block 406, in which the first mount and second mount are manipulated, wherein the first frame and the second frame can be manipulated at substantially the same time. In this embodiment, the robot can be manipulated, wherein the first mount and second mount are manipulated. In turn, the first frame and the second frame can be manipulated at substantially the same time. For example, as shown in FIG. 2, a robot, such as 204, can be controlled by a control device, such as a main control device described above with respect to FIG. 2A. The control device can manipulate the first mount 222 and second mount 224, wherein the first frame 212 and the second frame 214 can be manipulated at substantially the same time.

In one aspect of an embodiment, manipulating the first mount and second mount can include transmitting a command to a control device to manipulate the first frame, and transmitting another command to the control device to manipulate the second frame.

In one aspect of an embodiment, a suitable control device can be include at least one of the following: a programmable logic circuit (PLC), a software program, or a computer-readable medium comprising a set of computer-executable instructions.

In one aspect of an embodiment, the method 400 can include mounting at least one tool to either the first frame or the second frame. Example tools can include, but are not limited to, drills, rams, spindles, applicators, drills, and clamps.

In one aspect of an embodiment, manipulating the first frame and the second frame can include manipulating the first frame with respect to a product component, and manipulating the second frame with respect to the product component.

In one aspect of an embodiment, the product component can include at least one of the following: a bicycle, a motorcycle, an automobile, an airplane, an airplane wing, or an appliance.

In block 406, the method 400 ends.

The methods disclosed herein are by way of example only, and other methods in accordance with embodiments of the invention can include other elements or steps, including fewer or greater numbers of element or steps than the example method described herein.

While the above description contains many specifics, these specifics should not be construed as limitations on the scope of the invention, but merely as exemplifications of the disclosed embodiments. Those skilled in the art will envision many other possible variations that are within the scope of the invention as defined by the claims appended hereto.

The claimed invention is:

1. A system for manipulating a frame in a manufacturing process, the system comprising:
a first robot operable to manipulate a first frame;
a second robot operable to manipulate a second frame;
a control device capable of coordinating movement of the first robot and the second robot.

2. The system of claim 1, wherein the control device can manipulate the first robot with respect to a product component, and can further manipulate the second robot with respect to the product component.

3. The system of claim 1, comprising at least one tool operable to mount to either the first frame or the second frame.

4. The system of claim 3, wherein the control device can manipulate the at least one tool with respect to a product component.

5. The system of claim 1, wherein the first frame comprises one portion of a C-frame, and the second frame comprises another portion of the C-frame.

6. The system of claim 1, wherein the first frame mounts to the first robot, and the second frame mounts to the second robot.

7. The system of claim 1, wherein the first frame and the second frame can be manipulated by the system at substantially the same time.

8. The system of claim 1, wherein the first robot and second robot comprise an integrated robot.

9. The system of claim 1, wherein the control device comprises at least one of the following: a software program, a computer-readable medium comprising a set of computer-executable instructions, or programmable logic controller (PLC).

10. The system of claim 2, wherein the product component comprises at least one of the following: a bicycle, a motorcycle, an automobile, an airplane, an airplane wing, or an appliance.

11. A method for manipulating a frame in a manufacturing process, the method comprising:
providing at least one robot with a first mount operable to mount to a portion of a first frame, and a second mount operable to mount to a portion of a second frame;
mounting the first frame to the first mount, and mounting the second frame to the second mount; and
manipulating the first frame and the second frame via the at least one robot, wherein the first frame and the second frame can be manipulated at substantially the same time.

12. The method of claim 11, wherein the first frame is a portion of a C-frame, and the second frame is another portion of a C-frame.

13. The method of claim 11, wherein the at least one robot comprises at least a pair of robot arms, wherein the first mount is associated with one robot arm, and the second mount is associated with another robot arm.

14. The method of claim 11, wherein manipulating the first mount and second mount comprises transmitting a command to a control device to manipulate the first frame, and transmitting another command to the control device to manipulate the second frame.

15. The method of claim 11, further comprising:
mounting at least one tool to either the first frame or the second frame.

16. The method of claim 11, wherein manipulating the first frame and the second frame comprises manipulating the first frame with respect to a product component, and manipulating the second frame with respect to the product component.

17. The method of claim 16, wherein the product component comprises at least one of the following: a bicycle, a motorcycle, an automobile, an airplane, an airplane wing, or an appliance.

18. The method of claim 11, wherein manipulating the first frame and the second frame comprises transmitting at least one instruction to the at least one robot from at least one of the following: a software program, a computer-readable medium comprising a set of computer-executable instructions, or programmable logic controller (PLC).

19. A system for manufacturing a product component, the system comprising:
at least one robot comprising:
a first robot arm with at least one mount;
a second robot arm with at least one mount;
a frame comprising:
a first frame operable to mount to the first robot arm for manipulation by the first robot arm, and
a second frame operable to mount to the second robot for manipulation by the second robot arm;
at least one tool operable to mount to either the first frame or the second frame; and
a control device operable to coordinate simultaneous movement of the first robot arm and the second robot arm with respect to a product component, and further operable to manipulate the at least one tool with respect to the product component.

20. The system of claim 19, wherein the product component comprises at least one of the following: a bicycle, a motorcycle, an automobile, an airplane, an airplane wing, or an appliance.
